(19) United States
(12) Patent Application Publication
(10) Pub. No.: US 2026/0217003 A1
(43) Pub. Date: Jul. 30, 2026

(54) LAP-SEALABLE POLYETHYLENE FILMS AND SEALED PACKAGES

(71) Applicant: AMCOR FLEXIBLES NORTH AMERICA, INC., NEENAH, WI (US)

(72) Inventor: Bert DE SCHOENMAKER, LAARNE (BE)

(21) Appl. No.: 19/145,180

(22) PCT Filed: Jan. 26, 2023
(86) PCT No.: PCT/US2023/011573

§ 371 Date: Jul. 1, 2025

(51) Int. Cl. B32B 27/08; B32B 1/00; B32B 7/02; B32B 27/32

(52) U.S. Cl. CPC B32B 27/08; B32B 1/00; B32B 7/02; B32B 27/32; B32B 2250/04; B32B 2250/242; B32B 2255/10; B32B 2255/26; B32B 2307/31; B32B 2307/518; B32B 2307/72; B32B 2307/7376; B32B 2553/00

(57) ABSTRACT

Embodiments of the disclosure relate to oriented films (e.g., lap-sealable films including oriented films) and packages formed from oriented films. The oriented films described herein have a total composition comprising greater than or equal to 95% polyethylene, including greater than or equal to 99% polyethylene or 100% polyethylene, by weight. The oriented film comprises a first outer layer formed from a polymeric blend comprising in a range of from 50% to 80% of a first high density polyethylene (HDPE), by weight, and in a range of from 20% to 50% by weight of a polyethylene additive having a density less than or equal to 0.92 g/cm³, and a second outer layer comprising a second HDPE. In some embodiments, the oriented film includes one or more additional polyethylene layers. The lap-sealable films described herein have improved lap seal strength and improved stiffness after lamination.

### TECHNICAL FIELD

This disclosure is related to oriented films (e.g., lap-sealable films including oriented films) and sealed packages formed from, or including, oriented films as described herein.

### BACKGROUND

Polyethylene films, such as machine direction oriented polyethylene (MDOPE) films can be used to form flexible packages that are often used as packaging components for consumer, industrial, or medical products. Examples of MDOPE films are disclosed in International Publication Nos. WO2016/097951A1 and WO2017/102704A1.

There has been a shift in flexible packaging to move into more sustainable options. One of the main solutions is to make the entire structure from polyethylene-based materials, as these can be recycled in most countries. The goal of increasing recyclability of polyethylene films becomes challenging when attempting to form packaging films with specific seal performance requirements, such as lap sealing.

Most packaging does not involve lap seals, instead using fin seals or side seals to seal the inside of the package to itself (such as a candy bar wrapper, for example). A common area of use for a lap seal is on a potato chip bag, where the seal that runs the length of the bag involves sealing the inside of the film to the outside of the film—i.e., an overlap, or lap seal.

Traditionally, packaging film having both heat resistance and sealability is achieved by forming a multilayer film. Multilayer films contain a plurality of layers specific to forming layers providing enhanced sealing properties. When moving to PE based packages, a typical structure uses an oriented multilayer film containing a HDPE layer. This structure provides significant stiffness and heat resistance. However, traditional oriented HDPE films have poor or no lap seal performance.

Without contesting the associated advantages of the state-of-the-art film structures, there is a need for films having a total composition comprising high polyethylene content, by weight %, that have improved lap seal strength and improved stiffness after lamination.

### SUMMARY

Lap-sealable films can be used for packaging a wide variety of products including, but not restricted to food, cosmetics, lotions, lawn care products, cleaners/soaps, concentrates, industrial materials, pharmaceuticals, medical supplies, and medical devices.

Embodiments of the disclosure advantageously provide oriented films (e.g., lap-sealable films including oriented films) and sealed packages formed from, or including, lap-sealable oriented films having a total composition comprising high polyethylene content, by weight %, that have improved lap seal strength and improved stiffness after lamination. Additionally, this unique combination of layers and materials allows for an overall low thickness and increased stiffness, leading to excellent runnability (i.e., high run speed) on packaging equipment.

In one or more embodiments, an oriented film has a total composition comprising greater than or equal to 95% polyethylene, including greater than or equal to 98% polyethylene, or greater than or equal to 99% polyethylene. The oriented film comprises a first outer layer and a second outer layer. The first layer is formed from a polymeric blend comprising in a range of from 50% to 80% of a first high density polyethylene (HDPE), by weight, and in a range of from 20% to 50% by weight of a polyethylene additive having a density less than or equal to 0.92 g/cm³. The second outer layer comprises a second HDPE.

The oriented film may include one or more of a machine direction oriented polyethylene (MDOPE) film or a biaxially oriented polyethylene (BOPE) film. In some embodiments, the oriented film comprises a machine direction oriented polyethylene (MDOPE) film. In some embodiments, the oriented film comprises a biaxially oriented polyethylene (BOPE) film.

The polyethylene additive of the polymeric blend may comprise a plastomer. The polyethylene additive may comprise a linear α-olefin polymer. The polyethylene additive may have a seal-initiation temperature less than or equal to 110° C. In some embodiments, a polyethylene additive may also be present in the second outer layer, improving lamination of the second outer layer to other layers, such as a sealing layer.

In some embodiments, the second outer layer comprises greater than or equal to 95% of the second HDPE, including greater than or equal to 99% of the second HDPE or 100% of the second HDPE, by weight.

In some embodiments, the first outer layer has a thickness in a range of from 2 micron to 10 micron. In some embodiments, the second outer layer has a thickness in a range of from 2 micron to 40 micron, including in the range of from 5 micron to 30 micron, or in the range of from 5 micron to 25 micron.

In some embodiments, the oriented film further comprises a first inner layer between the first outer layer and the second outer layer. In some embodiments, the first inner layer comprises a medium density polyethylene (MDPE) having a density in a range of from 0.926 g/cm³ to 0.945 g/cm³. In some embodiments, the first inner layer has a thickness in a range of from 10 micron to 30 micron.

In some embodiments, the oriented film further comprises a second inner layer between the first inner layer and the first outer layer. In some embodiments, the second inner layer comprises a third HDPE. In some embodiments, the second inner layer comprises greater than or equal to 95% of the third HDPE, including greater than or equal to 99% of the third HDPE or 100% of the third HDPE, by weight. In some embodiments, the second inner layer has a thickness in a range of from 2 micron to 6 micron.

In some embodiments, the oriented film further comprises a barrier layer between the first outer layer and the sealing layer. In some embodiments, the barrier layer comprises one or more of ethylene vinyl alcohol (EVOH) or polyamide (PA).

In some embodiments, the oriented film has a total thickness in a range of from 12 micron to 50 micron. In some embodiments, the oriented film has a 1% secant modulus in a range of about 1,100 to about 2,000 N/mm². In further embodiments, the oriented film has a 1% secant modulus in a range of about 1,150 to about 1,800 N/mm².

In one or more embodiments, a lap-sealable film comprises a total composition having greater than or equal to 95% polyethylene, greater than or equal to 98% polyethylene, or greater than or equal to 99% polyethylene. In some embodiments, the lap-sealable film comprises the oriented film as described herein and a sealing layer connected to the second outer layer of the oriented film. In some embodiments, the sealing layer comprises a polyethylene material having a seal initiation temperature less than or equal to 110° C.

In some embodiments of the lap-sealable film, the polyethylene material of the sealing layer has a density less than or equal to 0.92 g/cm³. In some embodiments, the polyethylene material of the sealing layer comprises one or more of a polyethylene plastomer or a linear α-olefin polymer. In some embodiments, the sealing layer is coated on the second outer layer of the oriented film by extrusion coating.

In one or more embodiments, a package formed from the lap-sealable film further comprises at least one lap seal bonding the first outer layer of the oriented film to the sealing layer.

In one or more embodiments, a package formed from the lap-sealable film further comprises at least one fin seal bonding the sealing layer to itself.

In one or more embodiments, a package formed from the lap-sealable film comprises the oriented film as described herein, the sealing layer as described herein, at least one lap seal bonding the first outer layer of the oriented film to the sealing layer and at least one fin seal bonding the sealing layer to itself.

In one or more embodiments, a method of producing the lap-sealable film as described herein comprises coating the sealing layer on the second outer layer of the oriented film described herein by extrusion coating.

### BRIEF DESCRIPTION OF THE DRAWINGS

The disclosure may be more completely understood in consideration of the following detailed description of various embodiments of the disclosure in connection with the accompanying drawings, in which:

FIG. 1 illustrates a schematic cross-sectional view of an embodiment of an oriented film;

FIG. 2 illustrates a schematic cross-sectional view of an embodiment of an oriented film;

FIG. 3 illustrates a schematic cross-sectional view of an embodiment of an oriented film;

FIG. 4 illustrates a schematic cross-sectional view of an embodiment of a lap-sealable film;

FIG. 5 illustrates a schematic perspective view of an embodiment of a sealed package formed from the lap-sealable film; and

FIG. 6 illustrates a schematic cross-sectional view of an embodiment of a lap sealed package.

The Figures show some but not all embodiments. The elements depicted in the Figures are illustrative and not necessarily to scale, and the same (or similar) reference numbers denote the same (or similar) features throughout the Figures. It will be understood, however, that the use of a number to refer to a component in a given Figure is not intended to limit the component in another Figure labeled with the same number.

### DETAILED DESCRIPTION

The flexible packaging industry is moving toward more sustainable options, including streamlining of the materials used into narrow categories. For example, one option is to design packaging structures with high polyolefin content (e.g., high polyethylene content) in order to categorize the films as recyclable. Elimination of non-olefinic polymers from the packaging structures often presents deficiencies in the overall performance of the packaging structure.

The introduction of a selection of materials as described herein into the oriented film can reduce the negative effects of utilizing a more recyclable set of polymer materials. As a result, the oriented films described herein are more easily recyclable due to the high polyethylene content. The lap-sealable films made from the oriented films described herein have improved lap seal strength and improved stiffness after lamination.

Embodiments of the disclosure advantageously provide oriented films (e.g., lap-sealable films including oriented films) and sealed packages formed from, or including, lap-sealable films having a total composition comprising high polyethylene content and improved lap seal strength without compromising heat resistance and/or stiffness to an extent that formation of packages becomes difficult. It has been surprisingly discovered that the polymeric blend of HDPE and a polyethylene additive (e.g., one or more of a polyethylene plastomer or linear α-olefin polymer) described herein improves the lap seal strength to an acceptable range while still retaining enough heat resistance for package formation in a heat sealing process.

Additionally, this unique combination of layers and materials allows for an overall low thickness and increased stiffness, leading to excellent runnability (i.e., high run speed) on packaging equipment.

As used herein, the term “film” is a monolayer or multilayer web that has an insignificant z-direction dimension (thickness) as compared to the x- and y-direction dimensions (length and width). Films are generally regarded as having two major surfaces, opposite each other, expanding in the length and width directions. The innermost surface of the film, which is connected to another layer or film such that the innermost surface is not exposed may be referred to an “inner surface” or “interior surface.” The surface of the film that is not connected to another layer or film is an exposed surface (e.g., an outer surface or an exterior surface) of the film and may be referred to as an “exterior surface”. Films may be built from an unlimited number of films or layers; the films or layers being bonded together to form a multilayer film.

The term “layer”, as used herein, refers to a building block of films that is a structure of a single polymer or a homogeneous blend of materials. A layer may contain other non-polymeric materials and may have additives. Layers may be continuous or discontinuous (i.e., patterned) with the length and width of the film. In a monolayer film, “film”, “sheet” and “layer” are synonymous.

The term “multilayer”, as used herein, refers to a single film structure, which may have a plurality of layers, generally in the form of a sheet or web that can be made from a polymeric material or a non-polymeric material bonded together by any conventional means known in the art, (i.e., coextrusion, lamination, coating, or a combination thereof).

As used herein, layers or films that are “in direct contact with” or “are directly adjacent to” each other have no intervening material between them.

As used herein, the term “printed indicia layer” refers to a layer or series of sub-layers that have been printed onto a film. The layer or sub-layers may include pigment containing materials (i.e., colored ink), protective layers (i.e., over-lacquer) and ink receptive primers. Over-lacquer may protect a printed pigment layer and may improve the appearance of surface the film. Each of the printed indicia layer(s) may be independently continuous with the other layers of the film or independently discontinuous (i.e., patterned). Specifically, a printed indicia layer may include one or more continuous sub-layers of white pigmented print and one or more patterned sub-layers including other colors, thus producing the visible graphics for the packaging film.

As used herein, the term “barrier layer” refers to a layer that significantly reduces the transmission of one or more molecular species through the layer. A barrier layer may be a surface layer or an inner layer of a film. A barrier layer may limit or reduce the permeation of migratory species such as moisture, oxygen, and/or other gasses. Barrier layers are typically comprised of metals or polymers that are referred to as “barrier materials”. Barrier materials useful for thermoformable films and thermoformed components include, but are not limited to, ethylene vinyl alcohol copolymer (EVOH), polyvinylidene chloride (PVDC), high density polyethylene (HDPE), cyclic olefin copolymers (COC), polyamides (PA), polyacrylates, metals and metal oxides (i.e., SiOx or AlOx). Barrier layers may comprise blends of materials. The film may contain multiple barrier layers, that is, a second barrier layer, a third barrier layer, and so on. The film may further contain additional layers to provide bulk or adhesion, among other things.

The oriented films and lap seal film embodiments include as many layers as desired and, preferably, at least two layers. Oriented films that include at least three layers, include an inner layer between outer layers. As used throughout this application, the term “inner layer” refers to a layer that is positioned between two other layers. As used throughout this application, the term “outer layer” refers to a layer that does not have another layer connected to at least one of the major surfaces, (i.e., an outer layer is on the exterior surface of the film).

As used throughout this application, the term “polyethylene” or “PE” refers to, unless indicated otherwise, ethylene homopolymers as well as copolymers of ethylene with at least one alpha-olefin. The term will be used without regard to the presence or absence of substituent branch groups. Polyethylene includes, for example, medium density polyethylene, high density polyethylene, low density polyethylene, linear low-density polyethylene, ultra-low density polyethylene, ethylene alpha-olefin copolymer, or blends of such. As used herein, the term “polyethylene-based” refers to an article (i.e., a package, a film, a layer, etc.) that comprises high levels of polyethylene polymers. In some cases, a polyethylene-based article has at least 50% polyethylene polymers, by weight. Or a polyethylene-based article may have at least 60%, at least 70%, at least 80%, at least 90% or at least 95% polyethylene polymers, by weight. In some cases, a polyethylene-based article consists of polyethylene polymers.

As used throughout this application, the term “polyethylene additive” refers to, unless indicated otherwise, a polyethylene having a density less than or equal to 0.92 g/cm³. Exemplary polyethylene additives and/or polyethylene materials include polyethylene plastomers and linear α-olefin polymers. Examples of a linear α-olefin polymer include, but are not limited, to metallocene linear low density polyethylene (mLLDPE) and copolymers of 1-butene, 1-hexene or 1-octene. Examples of polyethylene plastomers include ethylene α-olefin polymers.

As used throughout this application, the terms “medium density polyethylene” or “MDPE” refer to a polyethylene having a density in a range of from 0.926 g/cm³ to 0.945 g/cm³.

The terms “high density polyethylene” or “HDPE”, as used herein, refer to both (a) homopolymers of ethylene which have densities from about 0.960 g/cm³ to about 0.970 g/cm³, and (b) copolymers of ethylene and an alpha-olefin (usually 1-butene or 1-hexene) which have densities from about 0.940 g/cm³ to about 0.958 g/cm³. HDPE includes polymers made with Ziegler or Phillips type catalysts and polymers made with single-site metallocene catalysts. HDPE also includes high molecular weight polyethylenes.

As described herein, the polyethylene-containing layers of the oriented film are oriented. Orientation may be the result of monoaxially oriented (machine direction or transverse direction), or biaxially oriented (machine direction and transverse direction) stretching of the film, increasing the machine direction and/or transverse direction dimension and subsequently decreasing the thickness of the material. Biaxial orientation may be imparted to the film simultaneously or successively. In some embodiments, the film stretched in either or both directions at a temperature just below the melt temperature of the polymers in the film. In this manner, the stretching causes the polymer chains to “orient”, changing the physical properties of the film. At the same time, the stretching thins the film. The resulting oriented films are thinner and can have significant changes in mechanical properties such as toughness, heat resistance, stiffness, tear strength and barrier. Orientation is typically accomplished by a double- or triple-bubble process, by a tenter-frame process or an MDO process using heated rolls. A typical blown film process does impart some stretching of the film, but not enough to be considered oriented as described herein. An oriented film may be heat set (i.e., annealed) after orientation, such that the film is relatively dimensionally stable (i.e., less than 10% free shrink) under elevated temperature conditions that might be experienced during conversion of the retort film laminate (i.e., printing or laminating) or during the use of the laminate (i.e., heat sealing or retort sterilization). As described herein, the sealing layer may be unoriented. As used herein, the terms “unoriented” and “non-oriented” refer to a monolayer or multilayer film, sheet or web that is substantially free of post-extrusion orientation.

The terms “polyamide” or “nylon”, as used herein, refer to homopolymers or copolymers having recurring amide linkages and may be formed by any method known in the art. Recurring amide linkages may be formed by the reaction of one or more diamines and one or more diacids. Non-limiting examples of suitable diamines include 1,4-diamino butane, hexamethylene diamine, decamethylene diamine, metaxylylene diamine and isophorone diamine. Non-limiting examples of suitable diacids include terephthalic acid, isophthalic acid, 2,5-furandicarboxylic acid, succinic acid, adipic acid, azelaic acid, capric acid and lauric acid.

As used throughout this application, the term “ethylene vinyl alcohol copolymer”, “EVOH copolymer” or “EVOH” refers to copolymers comprised of repeating units of ethylene and vinyl alcohol. Ethylene vinyl alcohol copolymers may be represented by the general formula: [(CH₂—CH₂)ₙ—(CH₂—CH(OH))]ₙ. Ethylene vinyl alcohol copolymers may include saponified or hydrolyzed ethylene vinyl acetate copolymers. EVOH refers to a vinyl alcohol copolymer having an ethylene co-monomer and prepared by, for example, hydrolysis of vinyl acetate copolymers or by chemical reactions with vinyl alcohol. Ethylene vinyl alcohol copolymers may comprise from 28 mole percent (or less) to 48 mole percent (or greater) ethylene. The type of EVOH may be selected to be one of the grades especially designed for thermoforming applications, as are known in the art. An example of a thermoformable EVOH is Soarnol™ ET3803 (38 mol % ethylene content) available from Soarus L.L.C. EVOH is known to reduce the permeation of oxygen and other gasses through polymeric based packaging films. EVOH includes a density from 0.93 g/cm³ to 0.97 g/cm³.

As used herein, the term “sealing layer” refers to a layer of a film, sheet, etc., involved in the sealing of the film, sheet, etc., to itself and/or to another layer of the same or another film, sheet, etc. As used herein, the terms “heat seal”, “heat sealed”, “heat sealing”, “heat sealable”, and the like, refer to both a film layer which is heat sealable to itself or other film layer, and the formation of a bond between two polymer surfaces by conventional indirect heating means. It will be appreciated that conventional indirect heating generates sufficient heat on at least one film contact surface for conduction to the contiguous film contact surface such that the formation of a bond interface therebetween is achieved without loss of the film integrity.

Heat sealing is a well-known and commonly used process for creating packages and is familiar to those skilled in the art. Without intending to be bound by theory, during heat sealing, the sealing layer softens due to the application of heat, allowing formation of a heat seal bond. Since the heat must be driven through the entire oriented film to raise the temperature of the sealable material, it is advantageous if the heat sealable material softens and seals at a relatively low temperature. Lower seal initiation temperature (SIT) enables faster packaging line speeds. For example, some embodiments of the oriented film (e.g., the lap-sealable film comprising the oriented film) may include a heat sealable material that exhibits an SIT of less than or equal to 110° C., less than or equal to 100° C., or less than or equal to 90° C. Possible heat sealable materials may include, but are not limited to, acrylate copolymers, PET, PE, PP or hot melts (wax based). Preferably, the heat sealing layer is comprised of polyethylene. Heat seal-initiation temperature and heat seal strength can be measured according to ASTM F88.

Lap-sealable films are formed by attaching a sealing layer to the second outer layer (i.e., the interior surface) of an oriented film. Additional layers may be added to the lap-sealable film, including, but not limited to, printed indicia layers, adhesive layers, and/or barrier layers. The lap-sealable films including an oriented film as described herein on an exposed surface, can be advantageously used to form hermetically sealed packages that include lap seals.

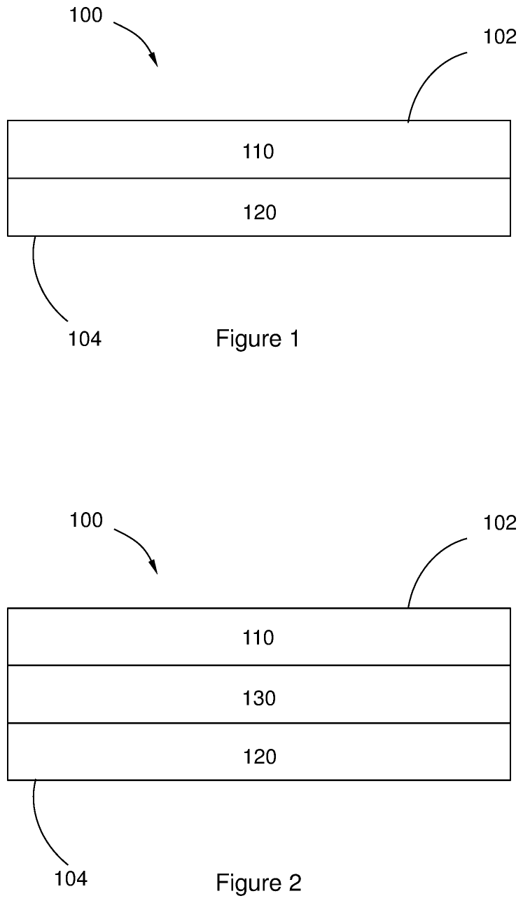

Embodiments of an oriented film structure are illustrated in FIGS. 1-3. Without being limited to any particular embodiment, any suitable method, including the methods described herein, may be used to form embodiments of the oriented film structure illustrated in FIGS. 1-3.

FIG. 1 illustrates a schematic cross-sectional view of an embodiment of an oriented film 100. The oriented film 100 has a total composition comprising greater than or equal to 95% polyethylene, including greater than or equal to 98% polyethylene, or greater than or equal to 99% polyethylene. The oriented film 100 has an exterior surface 102 and an interior surface 104. The oriented film 100 of FIG. 1 comprises a first outer layer 110 and a second outer layer 120. The first outer layer 110 is formed from a polymeric blend comprising in a range of from 50% to 80% of a first high density polyethylene (HDPE), by weight, and in a range of from 20% to 50% by weight of a polyethylene additive having a density less than or equal to 0.92 g/cm³. In some embodiments, the polyethylene additive of the polymeric blend comprises a plastomer. In some embodiments, the polyethylene of the polymeric blend comprises a linear α-olefin polymer. The second outer layer 120 comprises greater than or equal to 95% of the second HDPE, including greater than or equal to 99% of the second HDPE or 100% of the second HDPE, by weight. In some embodiments, the first HDPE and the second HDPE are the same.

The first outer layer 110 has a thickness in a range of from 2 micron to 10 micron. The second outer layer 120 has a thickness in a range of from 2 micron to 40 micron, including in the range of from 5 micron to 30 micron, or in the range of from 5 micron to 25 micron.

FIG. 2 illustrates a schematic cross-sectional view of an embodiment of an oriented film 100. The oriented film 100 has an exterior surface 102 and an interior surface 104. The oriented film 100 of FIG. 2 comprises a first outer layer 110, a second outer layer 120, and a first inner layer 130 between the first outer layer 110 and the second outer layer 120. In the illustrated embodiment of FIG. 2, the first outer layer 110 has a thickness in a range of from 2 micron to 6 micron and the second outer layer 120 has a thickness in a range of from 2 micron to 6 micron. The first inner layer 130 has a thickness in a range of from 10 micron to 30 micron.

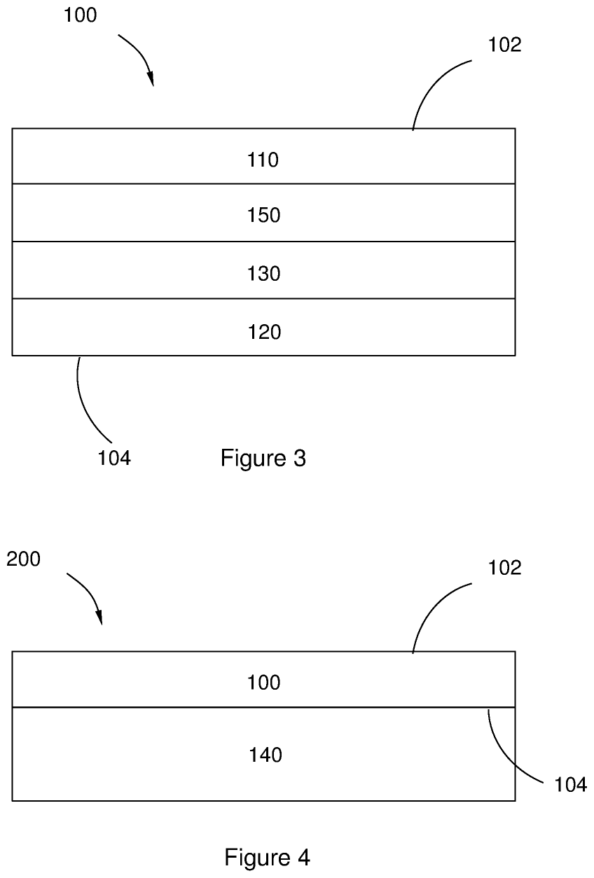

FIG. 3 illustrates a schematic cross-sectional view of an embodiment of an oriented film 100. The oriented film 100 has an exterior surface 102 and an interior surface 104. The oriented film 100 of FIG. 3 comprises a first outer layer 110, a second outer layer 120, a first inner layer 130 between the first outer layer 110 and the second outer layer 120 and a second inner layer 150 between the first inner layer 130 and the first outer layer 110. The second inner layer 150 comprises greater than or equal to 95% of a third HDPE, including greater than or equal to 99% of the third HDPE or 100% of the third HDPE, by weight. In some embodiments, the first HDPE, the second HDPE and the third HDPE are the same. In the illustrated embodiment of FIG. 3, the first outer layer 110 has a thickness in a range of from 2 micron to 6 micron and the second outer layer 120 has a thickness in a range of from 2 micron to 6 micron. The first inner layer 130 has a thickness in a range of from 10 micron to 30 micron. The second inner layer 150 has a thickness in a range of from 2 micron to 6 micron. In some embodiments, the oriented film 100 has a total thickness in a range of from 12 micron to 50 micron.

FIG. 4 illustrates a schematic cross-sectional view of an embodiment of a lap-sealable film 200 having a sealing layer 140 connected to the interior surface 104 of the oriented film 100. The sealing layer 140 is connected to the second outer layer (not shown) of the oriented film 100. The sealing layer 140 comprises a polyethylene material having a seal initiation temperature less than or equal to 110° C., including less than or equal to 100° C. and less than or equal to 90° C. In some embodiments, the polyethylene material of the sealing layer 140 has a density less than or equal to 0.92 g/cm³. In some embodiments, the polyethylene material of the sealing layer 140 comprises one or more of a polyethylene plastomer or a linear α-olefin polymer.

The sealing layer 140 may be attached to the second outer layer 120 (i.e., the interior surface 104) of the oriented film 100 by any suitable method known to the skilled artisan (e.g., printing, spray coat, knife coat, lamination, etc.). In some embodiments, the sealing layer 140 is coated on the second outer layer 120 of the oriented film 100 by extrusion coating. If extrusion coating is used, the sealing layer 140 is directly attached to the second outer layer 120, and the second outer layer 120 may advantageously comprise a blend of the second high density polyethylene, and a polyethylene plastomer or a linear α-olefin polymer.

In some embodiments, the sealing layer 140 is attached to the second outer layer 120 of the oriented film 100 by lamination, such as extrusion or adhesive lamination. If lamination is used, an adhesive layer is present between the sealing layer 140 and the second outer layer 120. The adhesive may be, but is not limited to, a two-component curing adhesive applied by coating (i.e., gravure) or a polymeric adhesive applied by extrusion. The sealing layer 140 may be part of a multilayer film.

The sealing layer 140 has a thickness in a range of from 5 micron to 100 micron, or in a range of from 5 micron to 75 micron, or in a range of from 10 micron to 75 micron.

In the illustrated embodiment of FIG. 4, the sealing layer 140 is laminated on the second outer layer (not shown) of the oriented film 100 to form the lap-sealable film 200. Additional layers may be added to the lap-sealable film 200, including, but not limited to, printed indicia layers, adhesive layers, and/or barrier layers.

In some embodiments, the lap-sealable film 200 further comprises a barrier layer (not shown) between the first outer layer 110 and the sealing layer 140. In some embodiments, the unillustrated barrier layer comprises one or more of ethylene vinyl alcohol (EVOH) or polyamide (PA), coextruded in the oriented film 100. In some embodiments, the unillustrated barrier layer comprises an extruded polymer layer (such as EVOH or PA) adjacent to the sealing layer, not within the oriented film. In some embodiments, the unillustrated barrier layer comprises a vacuum deposited material such as SiOx, AlOx, or aluminum, located on the interior surface 104 of the oriented film 100. In some embodiments, the unillustrated barrier layer comprises a coated material, such as polyvinyl alcohol (PVOH) or polyvinylidene chloride (PVdC), located on the interior surface 104 of the oriented film 100.

In some package embodiments, the oriented film 100 or the lap-sealable film 200 may be used to form flexible film packages such as stand-up pouches, pillow pouches, sachets, brick bags, flow wrap bags, stick packs, pillow packs, and the like. Advantageously, the lap-sealable film is used for package styles that include a lap seal configuration.

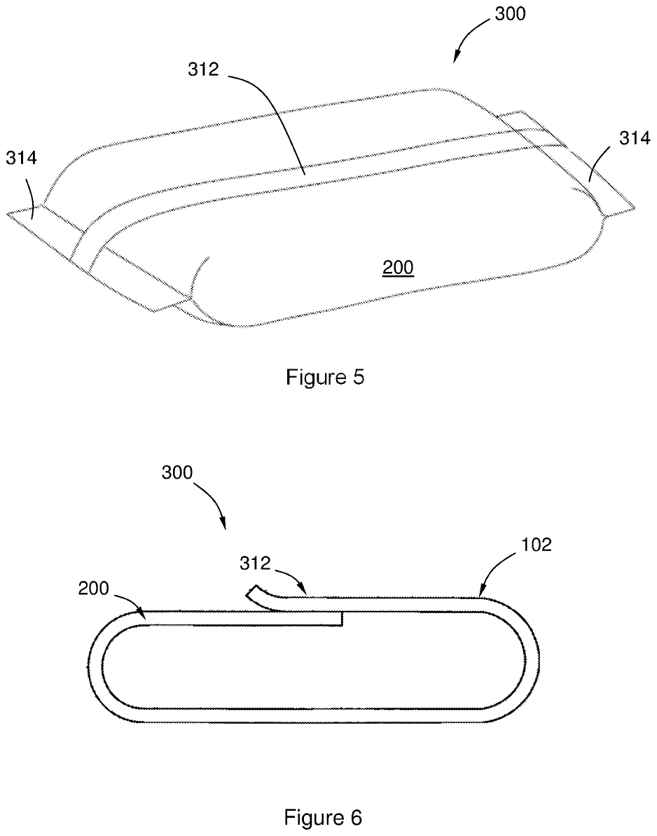

The packages or package components 300, such as the package illustrated in FIG. 5, may contain a variety of products, food or non-food, including but not limited to confectionary, snack bars, snack crisps, dry powders, liquids and pastes. Packages 300 formed from the lap-sealable films 200 disclosed herein are well suited to contain products that include a moisture content of greater than 30%, for example, 40%, 50%, 60%, 70%, 80%, 90%, 100%, or any moisture content therebetween. In an embodiment, packages 300 formed from the lap-sealable films 200 disclosed herein contain a product including a moisture content of greater than 30%. The oriented films and lap-sealable films disclosed herein can be advantageously used to package products that may be sensitive to moisture gain or loss, providing significant barrier to moisture transmission.

FIG. 5 illustrates a schematic perspective view of an embodiment of a hermetically sealed package 300 formed from the lap-sealable film 200 of FIG. 4. The lap-sealable film 200 has been formed by a flow wrap style packaging machine, sealing the lap-sealable film 200 around a product (not shown).

The lap-sealable film 200 is oriented such that the exterior surface 102 of the oriented film 100 is on the outside of the hermetically sealed package 300, visible by a consumer. Likewise, the interior surface 104 of the oriented film 100 (i.e., the side of the oriented film 100 that comprises the second outer layer 120 and has the sealing layer 140 thereon) is directed to the inside of the hermetically sealed package 300 (not shown). The sealing layer 140 is exposed to the packaged product. The hermetically sealed package 300 includes a lap seal 312 along the length of the package 300 and two end seals 314. The sealing layer 140 is connected to the second outer layer 120 of the oriented film 100 (not shown), at lap seal 312. The lap seal 312 bonds the sealing layer 140 to the exterior surface 102. The end seals 314 bond the sealing layer 140 to itself.

FIG. 6 illustrates a schematic cross-sectional view of an embodiment of the lap seal 312 in the package 300 of FIG. 5. In the illustrated embodiment of FIG. 5, the lap seal 312 extends along the length of and lays flat on the package 300.

The oriented films described herein may be recycled after their primary use is completed. The term “suitable for recycling”, as used herein, is meant to indicate that the film can be converted into a new, useful item by means of reprocessing in a recycle stream (e.g., recycling streams based on the thermoformable polymer or single polymer). Reprocessing may entail washing, separating, melting, and forming, among many other steps. Typically, when flexible polymeric packaging is recycled by reprocessing, the material is mechanically chopped into small pieces (e.g., granulated, flaked, etc.), melted, mixed, and reformed into the new product. If multiple incompatible materials are present in the packaging, interactions occur during reprocessing that can cause gels, brittle material, poor appearance, and generally unusable or poor quality products. Using the term “recyclable” indicates that these drawbacks generally are not present. Qualification as a recyclable material is not regulated by any specific agencies but can be obtained from groups such as the Association of Plastic Recyclers (APR) and How2Recycle™.

The embodiments of oriented films disclosed herein are recyclable films. The recyclable film includes a first film that includes greater than 95% of a single polymer. As used in this application, the term “single polymer”, may include a blend of the same category of a particular polymer type. In an embodiment, the first film may include greater than or equal to 95% of a polymeric blend of polyethylene-based polymers.

Being suitable for recycling may be obtained by keeping the overall amount of the single polymer in the oriented film at a high level. Any additives used should be kept to a minimum. Any other polymer types that are present should be minimized. The total composition of the oriented film may include between 90% and 100% of a single polymer (e.g., polyethylene), by weight, including any range or combination of ranges therein. In some embodiments, the total composition of the oriented film is greater than or equal to 90%, including greater than or equal to 95%, greater than or equal to 98% polyethylene, or greater than or equal to 99% polyethylene, by weight.

### Examples and Data

Various embodiments will be further clarified by the following examples.

Nine film samples were produced for testing. Each of Examples 1-6 and 8-9 and Comparative Example 7 were machine direction oriented films having a first outer layer having a thickness of about 5 micron, a first inner layer comprising 100% medium density polyethylene (Enable™ 3505MC, available from ExxonMobil, density 0.935 g/cm³ and melt index 0.50 g/10 min) and a thickness of about 15 micron, and a second outer layer comprising 100% high density polyethylene (Hostalen GF 9055 F available from LyondellBasell, density 0.954 g/cm³ and melt flow rate 1.8 g/10 min (190° C., 5 kg)), by weight, and having a thickness of about 5 micron. The composition of the first outer layer of Examples 1-6 and 8-9 and Comparative Example 7 are identified in Table 1.

TABLE 1
Identification of Polymeric Blend of First Outer Layer and Machine
Direction and Transverse Direction Secant Modulus at 1% Elongation
for Examples 1-6 and 8-9 and Comparative Example 7

| | Polymeric Blend of First Outer | Secant Modulus at 1% |
|---|---|---|
| Identification | Layer, % by weight | Elongation (N/mm²) |
| Example 1 | 60% HDPE and 40% PE1 | MD: 1050 |
| | | TD: 1350 |
| Example 2 | 60% HDPE and 40% PE2 | MD: 1050 |
| | | TD: 1350 |
| Example 3 | 60% HDPE and 40% PE3 | MD: 1050 |
| | | TD: 1350 |
| Example 4 | 80% HDPE and 20% PE1 | MD: 1300 |
| | | TD: 1500 |
| Example 5 | 90% HDPE and 10% PE1 | MD: 1400 |
| | | TD: 1600 |
| Example 6 | 95% HDPE and 5% PE1 | MD: 1450 |
| | | TD: 1600 |
| Comparative | 100% HDPE | MD: 1450 |
| Example 7 | | TD: 1600 |
| Example 8 | 80% HDPE and 20% PE4 | MD: 1300 |
| | | TD: 1500 |
| Example 9 | 60% HDPE and 40% PE4 | MD: 1050 |
| | | TD: 1350 |

PE1 = Queo ™ 0201 available from Borealis, an ethylene based octene-1 plastomer having 0.902 g/cm³ density, 1.1 g/10 min Melt Flow Rate and 78° C. seal initiation temperature
PE2 = Queo ™ 0203 available from Borealis, an ethylene based octene-1 plastomer having 0.902 g/cm³ density, 3 g/10 min Melt Flow Rate and 80° C. seal initiation temperature
PE3 = Queo ™ 8201 available from Borealis, an ethylene based octene-1 plastomer having 0.883 g/cm³ density and 1.1 g/10 min Melt Flow Rate
PE4 = Exceed ™ 1018MA available from ExxonMobil, an ethylene 1-hexene copolymer having 0.918 g/cm³ density and 1.0 g/10 min Melt Index

Table 1 also identifies the Secant Modulus at 1% Elongation measured in Machine Direction (MD) and Transverse Direction (TD) of the oriented films of Examples 1-6 and 8-9 and Comparative Example 7. The increased amount of plastomer in the first outer layer results in a lower stiffness (measured by Secant Modulus at 1% Elongation). In Examples 8-9 where a linear α-olefin polymer is used, the modulus is slightly higher than the polyethylene plastomer used in Examples 1-6. Overall, it appears that the density of the polyethylene additive material has no significant effect on the modulus and the melt flow rate (melt index) has a corresponding effect on modulus (i.e., higher MI leads to higher modulus).

TABLE 2
Identification of Example Polyethylene Layers and
Comparative Polyethylene Layers and Lap Seal Strength
as a Function of Sealing Temperature

| | Lap Seal | Lap Seal | Lap Seal | Lap Seal |
|---|---|---|---|---|
| | Strength | Strength | Strength | Strength |
| | (N/15 mm) at | (N/15 mm) | (N/15 mm) | (N/15 mm) |
| Identification | 100° C. | at 110° C. | at 120° C. | at 130° C. |
| Example 1 | 0.4 | 2.6 | 2.7 | 4.0 |
| Example 2 | 1.0 | 3.0 | 2.6 | 4.0 |
| Example 3 | 1.4 | 3.9 | 5.4 | 5.2 |
| Example 4 | 0.4 | 2.6 | 2.7 | 4.0 |
| Example 5 | 0.4 | 0.9 | 1.6 | 3.3 |
| Example 6 | 0.8 | 1.6 | 1.8 | 2.4 |
| Comparative | 0.3 | 0.6 | 1.1 | 2.3 |
| Example 7 | | | | |
| Example 8 | 0.3 | 0.5 | 1.1 | 2.8 |
| Example 9 | 0.5 | 0.5 | 1.8 | 3.5 |

Table 2 identifies lap seal strength as a function of sealing temperature. Table 2 shows Lap Seal Strength (N/15 mm) measured at sealing temperatures of 100° C., 110° C., 120° C. and 130° C. Heat seals were produced on standard sealing equipment (Kopp SGPE20) using a pressure of 400 N/20 cm² and a seal dwell time of 1 second. Seal strength was tested on a standard tensile testing unit (Hounsfield 1 ST) using a 250 N load cell and a pulling speed of 300 mm/min. The seal strengths shown in Table 2 are average peel force across a 15 mm sample width. The seals were produced with the first outer layer sealing to the second outer layer.

The data in Table 2 indicates that the higher amount of polyethylene plastomer, the greater the lap seal strength (i.e., higher N/15 mm value) at lower temperatures. For instance, the first outer layer of Example 1 comprises 60% HDPE and 40% polyethylene plastomer, by weight, and has a seal strength of 2.6 N/15 mm at 110° C., as compared to Comparative Example 7 comprising a first outer layer of 100% HDPE and having a seal strength of 0.6 N/15 mm at 110° C. In Examples 8-9 where a linear α-olefin polymer is used, the seal strength begins to increase at higher temperatures, beginning at 120° C. Additionally, Table 2 shows that the lower density polyethylene plastomer (Example 3) has an increased lap seal strength compared to all other Examples.

TABLE 3
Identification of Heat Resistance of Examples
and Comparative Examples Upon Heat Sealing

| | Heat | Heat | Heat | Heat | Heat |
|---|---|---|---|---|---|
| | resistance | resistance | resistance | resistance | resistance |
| | characteristics | characteristics | characteristics | characteristics | characteristics |
| Identification | at 90° C. | at 100° C. | at 110° C. | at 120° C. | at 130° C. |
| Example 1 | Seal: No | Seal: No | Seal: Some | Seal: | Seal: |
| | deformities | deformities | deformation | Deformation, | Deformation, |
| | Area around | Area around | (curved seal | small | shrinkage, |
| | seal: No | seal: No | and haziness | shrinkage, | jaw sticking |
| | deformities | deformities | of the seal) | haziness and | and molten |
| | | | Area around | sticky | Area around |
| | | | seal: Some | Area around | seal: |
| | | | deformation | seal: Some | Deformation |
| | | | (curves at | deformation | (curves at |
| | | | seal edges) | (curves at | seal) |
| | | | | seal edges) | |
| Example 2 | Seal: No | Seal: No | Seal: Some | Seal: | Seal: |
| | deformities | deformities | deformation | Deformation, | Deformation, |
| | Area around | Area around | (curved seal | small | shrinkage, |
| | seal: No | seal: No | and haziness | shrinkage, | jaw sticking |
| | deformities | deformities | of the seal) | haziness and | and molten |
| | | | Area around | sticky | Area around |
| | | | seal: Some | Area around | seal: |
| | | | deformation | seal: Some | Deformation |
| | | | (curves at | deformation | (curves at |
| | | | seal edges) | (curves at | seal) |
| | | | | seal edges) | |
| Example 3 | Seal: No | Seal: No | Seal: Some | Seal: | Seal: |
| | deformities | deformities | deformation | Deformation, | Deformation, |
| | Area around | Area around | (curved seal | small | shrinkage, |
| | seal: No | seal: No | and haziness | shrinkage, | jaw sticking |
| | deformities | deformities | of the seal) | haziness and | and molten |
| | | | Area around | some | Area around |
| | | | seal: Some | stickiness | seal: |
| | | | deformation | Area around | Deformation |
| | | | (curves at | seal: Some | (curves at |
| | | | seal edges) | deformation | seal) |
| | | | | (curves at | |
| | | | | seal edges) | |
| Example 4 | Seal: No | Seal: No | Seal: Some | Seal: | Seal: |
| | deformities | deformities | deformation | Deformation, | Deformation, |
| | Area around | Area around | (curved seal | small | shrinkage, |
| | seal: No | seal: No | and haziness | shrinkage, | jaw sticking |
| | deformities | deformities | of the seal) | haziness and | and molten |
| | | | Area around | some | Area around |
| | | | seal: Some | stickiness | seal: |
| | | | deformation | Area around | Deformation |
| | | | (curves at | seal: Some | (curves at |
| | | | seal edges) | deformation | seal) |
| | | | | (curves at | |
| | | | | seal edges) | |
| Example 5 | Seal: No | Seal: No | Seal: Some | Seal: | Seal: |
| | deformities | deformities | deformation | Deformation, | Deformation, |
| | Area around | Area around | (curved seal | small | shrinkage, |
| | seal: No | seal: No | and haziness | shrinkage, | jaw sticking |
| | deformities | deformities | of the seal) | haziness and | and molten |
| | | | Area around | some | Area around |
| | | | seal: Some | stickiness | seal: |
| | | | deformation | Area around | Deformation |
| | | | (curves at | seal: Some | (curves at |
| | | | seal edges) | deformation | seal) |
| | | | | (curves at | |
| | | | | seal edges) | |
| Example 6 | Seal: No | Seal: No | Seal: Some | Seal: | Seal: |
| | deformities | deformities | deformation | Deformation, | Deformation, |
| | Area around | Area around | (curved seal | small | shrinkage, |
| | seal: No | seal: No | and haziness | shrinkage, | jaw sticking |
| | deformities | deformities | of the seal) | haziness and | and molten |
| | | | Area around | some | Area around |
| | | | seal: Some | stickiness | seal: |
| | | | deformation | Area around | Deformation, |
| | | | (curves at | seal: Some | shrinkage, |
| | | | seal edges) | deformation | jaw sticking |
| | | | | (curves at | and molten |
| | | | | seal edges) | |
| Comparative | Seal: No | Seal: No | Seal: Some | Seal: | Seal: |
| Example 7 | deformities | deformities | deformation | Deformation, | Deformation, |
| | Area around | Area around | (curved seal | small | shrinkage, |
| | seal: No | seal: No | and haziness | shrinkage, | jaw sticking |
| | deformities | deformities | of the seal) | haziness and | and molten |
| | | | Area around | no stickiness | Area around |
| | | | seal: Some | Area around | seal: |
| | | | deformation | seal: Some | Deformation, |
| | | | (curves at | deformation | shrinkage, |
| | | | seal edges) | (curves at | jaw sticking |
| | | | | seal edges) | and molten |
| Example 8 | Seal: No | Seal: No | Seal: Some | Seal: | Seal: |
| | deformities | deformities | deformation | Deformation, | Deformation, |
| | Area around | Area around | (curved seal | small | shrinkage, |
| | seal: No | seal: No | and haziness | shrinkage, | jaw sticking |
| | deformities | deformities | of the seal) | haziness and | and molten |
| | | | Area around | no stickiness | Area around |
| | | | seal: Some | Area around | seal: |
| | | | deformation | seal: Some | Deformation |
| | | | (curves at | deformation | (curves at |
| | | | seal edges) | (curves at | seal) |
| | | | | seal edges) | |
| Example 9 | Seal: No | Seal: No | Seal: Some | Seal: | Seal: |
| | deformities | deformities | deformation | Deformation, | Deformation, |
| | Area around | Area around | (curved seal | small | shrinkage, |
| | seal: No | seal: No | and haziness | shrinkage, | jaw sticking |
| | deformities | deformities | of the seal) | haziness and | and molten |
| | | | Area around | no stickiness | Area around |
| | | | seal: Some | Area around | seal: |
| | | | deformation | seal: Some | Deformation, |
| | | | (curves at | deformation | shrinkage, |
| | | | seal edges) | (curves at | jaw sticking |
| | | | | seal edges) | and molten |

Table 3 identifies heat resistance characteristics of the test films at the “Seal” and “Area around the Seal” measured at seal temperatures of 90° C., 100° C., 110° C., 120° C. and 130° C. Samples were heat sealed as described above in the method used to produce samples for heat seal strength testing.

Table 3 indicates that there is a difference in stickiness to the seal bar with increasing amount of polyethylene plastomer. For example, typical machine direction oriented (MDO) polyethylene (PE) is not sticky and has poor lap seal performance (e.g., Comparative Example 7 at 120° C.), while Examples 1-6 having polyethylene plastomer have at least some stickiness and lap seal capability. Examples 8-9, however, have similar heat resistance properties to Comparative Example 7.

The above description and examples illustrate certain embodiments of the present disclosure and are not to be interpreted as limiting. Selection of particular embodiments, combinations thereof, modifications, and adaptations of the various embodiments, conditions and parameters normally encountered in the art will be apparent to those skilled in the art and are deemed to be within the spirit and scope of the present invention.

### EMBODIMENTS

Embodiment 1: An oriented film comprising: a first outer layer formed from a polymeric blend comprising in a range of from 50% to 80% of a first high density polyethylene (HDPE), by weight, and in a range of from 20% to 50% by weight of a polyethylene additive having a density less than or equal to 0.92 g/cm³, a second outer layer comprising a second HDPE, and a total composition comprising greater than or equal to 95% polyethylene.
Embodiment 2: The oriented film according to Embodiment 1, wherein the oriented film comprises a biaxially oriented polyethylene (BOPE) film.
Embodiment 3: The oriented film according to any previous Embodiment, wherein the oriented film comprises a machine direction oriented polyethylene (MDOPE) film.
Embodiment 4: The oriented film according to any previous Embodiment, wherein the polyethylene additive comprises a plastomer.
Embodiment 5: The oriented film according to any previous Embodiment, wherein the polyethylene additive comprises a linear α-olefin polymer.
Embodiment 6: The oriented film according to any previous Embodiment, wherein the polyethylene additive has a seal-initiation temperature less than or equal to 110° C.
Embodiment 7: The oriented film according to any previous Embodiment, wherein the second outer layer comprises greater than or equal to 95% of the second HDPE, including greater than or equal to 99% of the second HDPE or 100% of the second HDPE, by weight.
Embodiment 8: The oriented film according to any previous Embodiment, wherein the first outer layer has a thickness in a range of from 2 micron to 10 micron.
Embodiment 9: The oriented film according to any previous Embodiment, wherein the second outer layer has a thickness in a range of from 2 micron to 40 micron.
Embodiment 10: The oriented film according to any previous Embodiment, further comprising a first inner layer between the first outer layer and the second outer layer.
Embodiment 11: The oriented film according to Embodiment 10, wherein the first inner layer comprises a medium density polyethylene (MDPE) having a density in a range of from 0.926 g/cm³ to 0.945 g/cm³.
Embodiment 12: The oriented film according to Embodiment 11, wherein the first inner layer has a thickness in a range of from 10 micron to 30 micron.
Embodiment 13: The oriented film according to any previous Embodiment, further comprising a second inner layer between the first inner layer and the first outer layer, the second inner layer comprising a third HDPE.
Embodiment 14: The oriented film according to Embodiment 13, wherein the second inner layer comprises greater than or equal to 95% of the third HDPE, including greater than or equal to 99% of the third HDPE or 100% of the third HDPE, by weight.
Embodiment 15: The oriented film according to Embodiment 13, wherein the second inner layer has a thickness in a range of from 2 micron to 6 micron.
Embodiment 16: The oriented film according to any previous Embodiment, the oriented film has a total thickness in a range of from 12 micron to 50 micron.
Embodiment 17: The oriented film according to any previous Embodiment, wherein the oriented film has a 1% secant modulus in a range of about 1100 to about 2000 N/mm².
Embodiment 18: A lap-sealable film comprising: the oriented film according to any previous Embodiment, and a sealing layer connected to the second outer layer of the oriented film, wherein the sealing layer comprises a polyethylene material having a seal initiation temperature less than or equal to 110° C., and the lap-sealable film comprises a total composition having greater than or equal to 95% polyethylene.
Embodiment 19: The lap-sealable film according to Embodiment 18, wherein the polyethylene material of the sealing layer has a density less than or equal to 0.92 g/cm³.
Embodiment 20: The lap-sealable film according to any of Embodiments 18-19, wherein the polyethylene material of the sealing layer comprises one or more of a polyethylene plastomer or a linear α-olefin polymer.
Embodiment 21: The lap-sealable film according to any of Embodiments 18-20, further comprising a barrier layer between the first outer layer and the sealing layer.
Embodiment 22: The lap-sealable film according to Embodiment 21, wherein the barrier layer comprises one or more of ethylene vinyl alcohol (EVOH) or polyamide (PA).
Embodiment 23: A package formed from the lap-sealable film according to any of Embodiments 18-22, wherein the package further comprises at least one lap seal bonding the first outer layer of the oriented film to the sealing layer.
Embodiment 24: A package formed from the lap-sealable film according to any of Embodiments 18-23, wherein the package further comprises at least one fin seal bonding the sealing layer to itself.
Embodiment 25: A package comprising a lap-sealable film, the lap-sealable film comprising: an oriented film having a first outer layer formed from a polymeric blend comprising in a range of from 60% to 80% of a first high density polyethylene (HDPE), by weight, and in a range of from 20% to 40% of a polyethylene plastomer, by weight, the polyethylene plastomer having a density less than or equal to 0.92 g/cm³, the oriented film having at least one inner layer comprising one or more of a medium density polyethylene (MDPE) or a second HDPE, a sealing layer coated on one side of the oriented film by extrusion coating, the sealing layer comprising a polyethylene plastomer having a seal initiation temperature below 110° C., at least one lap seal, and at least one fin seal, wherein the first outer layer of the oriented film and the sealing layer form a plurality of outer layers, the at least one lap seal is configured to bond the first outer layer and the sealing layer, the at least one fin seal is configured to bond the sealing layer to itself, and the lap-sealable film comprises a total composition comprising greater than or equal to 95% polyethylene.

1. An oriented film comprising:
a first outer layer formed from a polymeric blend comprising in a range of from 50% to 80%, by weight, of a first high density polyethylene (HDPE) and in a range of from 20% to 50%, by weight, of a polyethylene additive having a density less than or equal to 0.92 g/cm³,
a second outer layer comprising a second HDPE, and
a total composition comprising greater than or equal to 95% polyethylene.

2. The oriented film according to claim 1, wherein the oriented film comprises a biaxially oriented polyethylene (BOPE) film.

3. The oriented film according to claim 1, wherein the oriented film comprises a machine direction oriented polyethylene (MDOPE) film.

4. The oriented film according to claim 1, wherein the polyethylene additive comprises a plastomer.

5. The oriented film according to claim 1, wherein the polyethylene additive comprises a linear α-olefin polymer.

6. The oriented film according to claim 1, wherein the polyethylene additive has a seal-initiation temperature less than or equal to 110° C.

7. The oriented film according to claim 1, wherein the second outer layer comprises greater than or equal to 95% of the second HDPE, including greater than or equal to 99% of the second HDPE or 100% of the second HDPE, by weight.

8. The oriented film according to claim 1, wherein the first outer layer has a thickness in a range of from 2 micron to 10 micron.

9. The oriented film according to claim 1, wherein the second outer layer has a thickness in a range of from 2 micron to 40 micron.

10. The oriented film according to claim 1, further comprising a first inner layer between the first outer layer and the second outer layer.

11. The oriented film according to claim 10, wherein the first inner layer comprises a medium density polyethylene (MDPE) having a density in a range of from 0.926 g/cm³ to 0.945 g/cm³.

12. The oriented film according to claim 11, wherein the first inner layer has a thickness in a range of from 10 micron to 30 micron.

13. The oriented film according to claim 1, further comprising a second inner layer between the first inner layer and the first outer layer, the second inner layer comprising a third HDPE.

14. The oriented film according to claim 13, wherein the second inner layer comprises greater than or equal to 95% of the third HDPE, including greater than or equal to 99% of the third HDPE or 100% of the third HDPE, by weight.

15. The oriented film according to claim 13, wherein the second inner layer has a thickness in a range of from 2 micron to 6 micron.

16. The oriented film according to claim 1, the oriented film has a total thickness in a range of from 12 micron to 50 micron.

17. The oriented film according to claim 1, wherein the oriented film has a 1% secant modulus in a range of about 1,100 to about 2,000 N/mm².

18. A lap-sealable film comprising:
the oriented film according to claim 1, and
a sealing layer connected to the second outer layer of the oriented film,
wherein the sealing layer comprises a polyethylene material having a seal initiation temperature less than or equal to 110° C., and the lap-sealable film comprises a total composition having greater than or equal to 95% polyethylene.

19. The lap-sealable film according to claim 18, wherein the polyethylene material of the sealing layer has a density less than or equal to 0.92 g/cm³.

20. The lap-sealable film according to claim 18, wherein the polyethylene material of the sealing layer comprises one or more of a polyethylene plastomer or a linear α-olefin polymer.

21. The lap-sealable film according to claim 18, further comprising a barrier layer between the first outer layer and the sealing layer.

22. The lap-sealable film according to claim 21, wherein the barrier layer comprises one or more of ethylene vinyl alcohol (EVOH) or polyamide (PA).

23. A package formed from the lap-sealable film according to claim 18, wherein the package further comprises at least one lap seal bonding the first outer layer of the oriented film to the sealing layer.

24. A package formed from the lap-sealable film according to claim 18, wherein the package further comprises at least one fin seal bonding the sealing layer to itself.

25. A package comprising a lap-sealable film, the lap-sealable film comprising:
an oriented film having a first outer layer formed from a polymeric blend comprising in a range of from 60% to 80% of a first high density polyethylene (HDPE), by weight, and in a range of from 20% to 40% of a polyethylene plastomer, by weight, the polyethylene plastomer having a density less than or equal to 0.92 g/cm³, the oriented film having at least one inner layer comprising one or more of a medium density polyethylene (MDPE) or a second HDPE,
a sealing layer coated on one side of the oriented film by extrusion coating, the sealing layer comprising a polyethylene plastomer having a seal initiation temperature below 110° C.,
at least one lap seal, and
at least one fin seal,
wherein the first outer layer of the oriented film and the sealing layer form a plurality of outer layers, the at least one lap seal is configured to bond the first outer layer and the sealing layer, the at least one fin seal is configured to bond the sealing layer to itself, and the lap-sealable film comprises a total composition comprising greater than or equal to 95% polyethylene.
